(19) United States
(12) Patent Application Publication
(10) Pub. No.: US 2014/0099526 A1
(43) Pub. Date: Apr. 10, 2014

(54) HAND-HELD ELECTRONIC DEVICE ACCESSORY THAT FACILITATES RAPID BATTERY REPLACEMENT

(71) Applicant: The Code Corporation, Bluffdale, UT (US)

(72) Inventors: George Powell, Sandy, UT (US); Ryan Hoobler, Salt Lake City, UT (US); Ming Lei, Princeton Junction, NJ (US); Garrett Russell, Phoenixville, PA (US); Mark Ashby, Taylorsville, UT (US)

(73) Assignee: The Code Corporation, Bluffdale, UT (US)

(21) Appl. No.: 13/644,356

(22) Filed: Oct. 4, 2012

(51) Int. Cl. H01M 2/10; G06K 7/00; G06K 7/08; H02J 7/00; G06K 7/10

(52) U.S. Cl. CPC H01M 2/1022; H02J 7/007; G06K 7/10881; G06K 7/089; G06K 7/0004
USPC 429/100; 320/103; 235/462.45; 235/449

(57) ABSTRACT

An accessory for a hand-held electronic device includes a protective case and a battery. The electronic device is insertable into the protective case. The battery may be utilized to provide auxiliary power to the electronic device. The battery may be replaceable without having to remove the electronic device from the protective case.

### TECHNICAL FIELD

The present disclosure relates generally to hand-held electronic devices.

### BACKGROUND

Many different types of hand-held electronic devices are in widespread use today, most often in connection with entertainment, communications and office productivity. Examples of hand-held electronic devices include mobile phones, smartphones, portable media players, digital cameras, camcorders, GPS navigation devices, etc.

### BRIEF DESCRIPTION OF THE DRAWINGS

FIGS. 1A through 1C illustrate one configuration of an accessory for a hand-held electronic device.

FIGS. 2A through 2C illustrate another configuration of an accessory for a hand-held electronic device.

FIGS. 3A through 3C illustrate another configuration of an accessory for a hand-held electronic device.

FIGS. 4A through 4B illustrate another configuration of an accessory for a hand-held electronic device.

### DETAILED DESCRIPTION

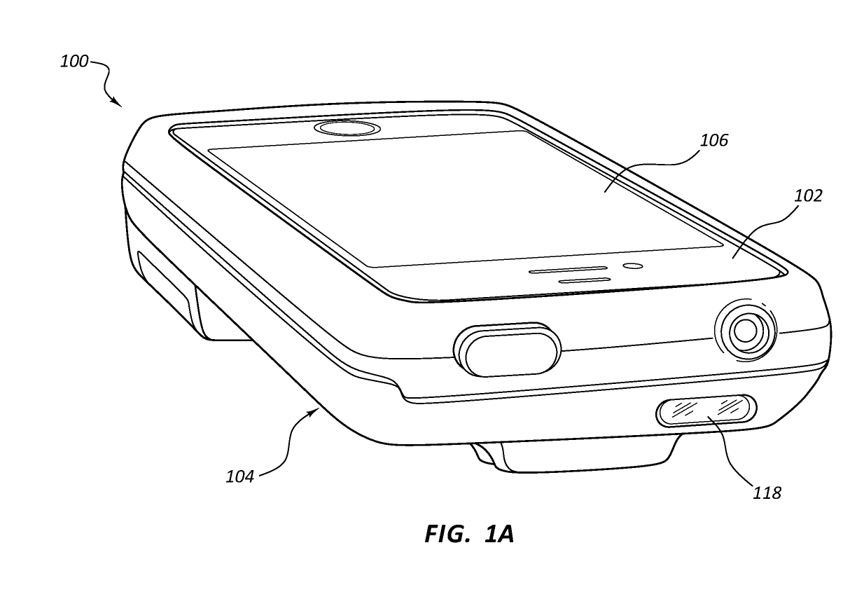

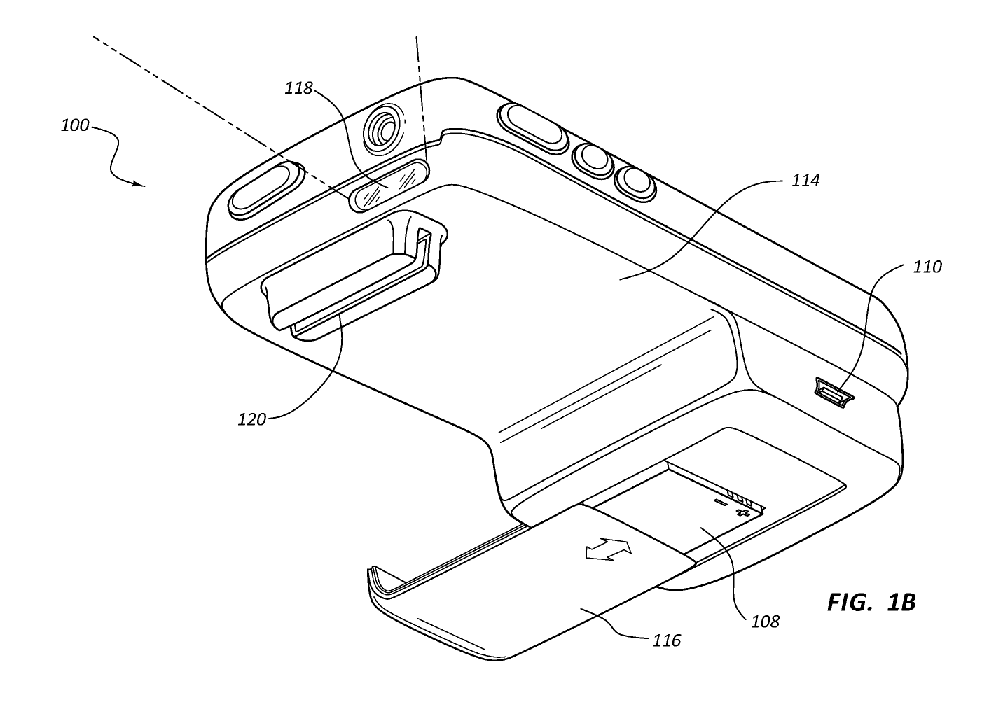

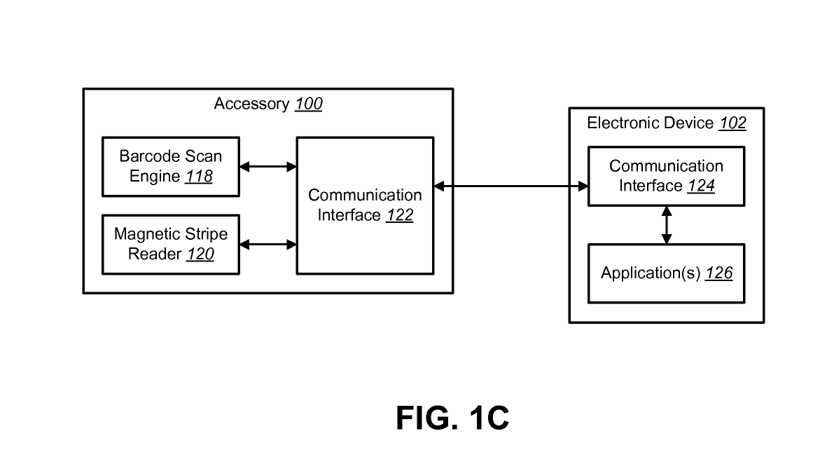

FIGS. 1A through 1C illustrate one configuration of an accessory 100 for a hand-held electronic device 102. The accessory 100 includes a protective case 104. The electronic device 102 is insertable into the protective case 104. When the electronic device 102 has been inserted into the protective case 104, the protective case 104 provides a relatively hard outer shell that encompasses the side portions and the back portion of the electronic device 102. The display screen 106 of the electronic device 102 remains visible, but may be protected by a clear cover, after the electronic device 102 has been inserted into the protective case 104.

In the depicted configuration, it is assumed that the electronic device 102 is a smartphone or a portable media player. Consequently, the accessory 100 is shaped so that a smartphone or a portable media player may be inserted into the accessory 100. However, alternative configurations of an accessory in accordance with the present disclosure may be designed and shaped for use in connection with other types of electronic devices, including any of those mentioned previously.

The accessory 100 includes a battery 108 that provides auxiliary power to the electronic device 102. The accessory 100 may be configured so that when the electronic device 102 is not connected to a DC power source and the internal battery of the electronic device 102 becomes depleted, the electronic device 102 receives power from the battery 108 of the accessory 100. Thus, the accessory 100 may perform the function of extending the life of the electronic device's 102 internal battery. The battery 108 also provides power to the accessory 100.

The battery 108 is replaceable without having to remove the electronic device 102 from the protective case 104. The protective case 104 includes a back side 114 (shown in FIG. 1B). An exterior surface of the back side 114 of the protective case 104 includes a battery cover 116. Replacing the battery 108 comprises opening the battery cover 116, removing the battery 108 from the accessory 100, inserting a new battery into the accessory 100, and closing the battery cover 116.

In the depicted configuration, opening the battery cover 116 comprises sliding the battery cover 116 in one direction, and closing the battery cover 116 comprises sliding the battery cover 116 in the opposite direction. The battery cover 116 does not become detached from the protective case 104 when the battery cover 116 is opened or closed. However, other types of configurations may be utilized instead. For example, in one alternative configuration, the battery cover may be opened by completely detaching the battery cover from the protective case, and the battery cover may be closed by reattaching the battery cover to the protective case. In another alternative configuration, the battery cover may be attached to the protective case via a hinge. In such a configuration, the battery cover may be opened by lifting up on one side of the cover, and the battery cover may be closed by pushing down on the same side of the battery cover.

The battery 108 may be rechargeable. There are many different types of rechargeable batteries 108 that may be used (e.g., lithium-ion, lithium-ion polymer, nickel-cadmium, nickel-metal hydride, etc.). The accessory 100 comprises a power interface 110 that enables the accessory 100 to be connected to a power source (e.g., an electrical outlet, a personal computer, a docking station, etc.) in order to charge the battery 108. The power interface 110 may comprise a type of USB interface (e.g., micro, mini, or standard).

The accessory 100 also comprises a barcode scan engine 118, which scans and decodes barcodes. The barcode scan engine 118 may be configured to scan and decode one-dimensional and/or two-dimensional barcodes. The barcode scan engine 118 may be, for example, the Code Reader™ 8000 Scan Engine, which is sold commercially by The Code Corporation (the assignee of the present application). However, another barcode scan engine 118 may be utilized instead.

The accessory 100 may also include a magnetic stripe reader 120, which reads magnetic stripe cards. A magnetic stripe card is a type of card that includes a band of magnetic material (referred to as a magnetic stripe), and that stores data by modifying the magnetism of iron-based magnetic particles on the magnetic stripe. Examples of magnetic stripe cards include credit cards, driver's licenses, access badges, etc.

The accessory 100 also includes a communication interface 122 (shown in FIG. 1C). The electronic device 102 may include a similar communication interface 124. The communication interfaces 122, 124 may be, for example, RS232 interfaces. Data that is generated by the barcode scan engine 118 and data that is generated by the magnetic stripe reader 120 may be provided to the electronic device 102 via the communication interfaces 122, 124. The electronic device 102 may include one or more applications 126 that read the communication interface 124 in order to obtain the data from the barcode scan engine 118 and/or the magnetic stripe reader 120.

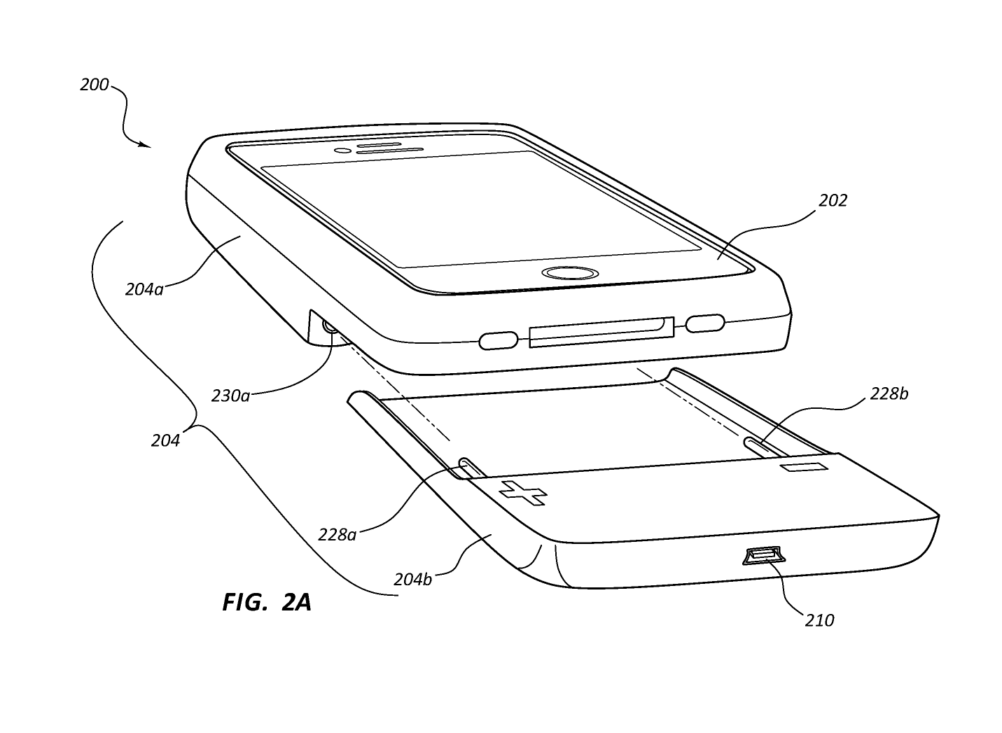

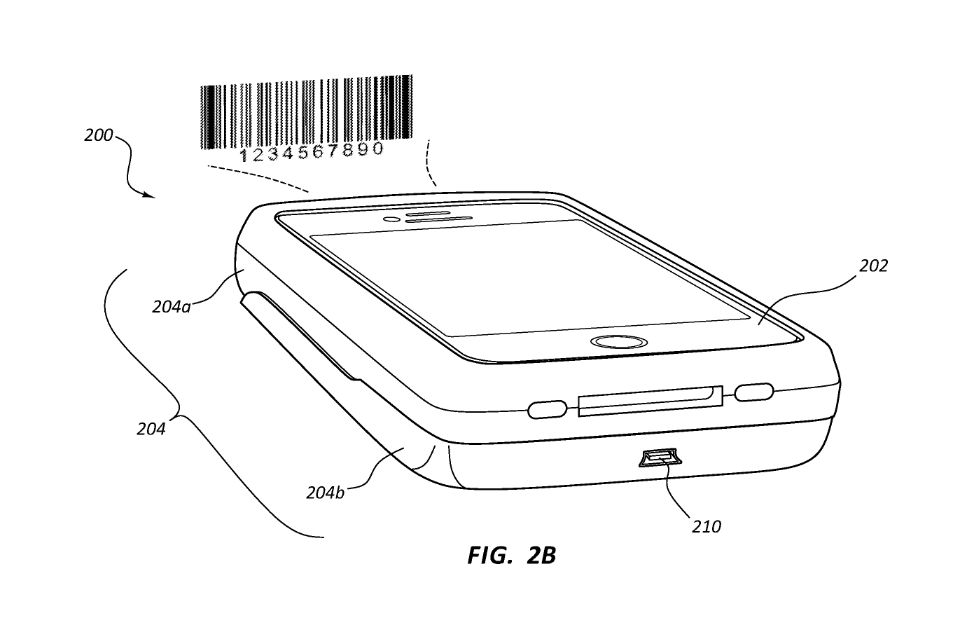

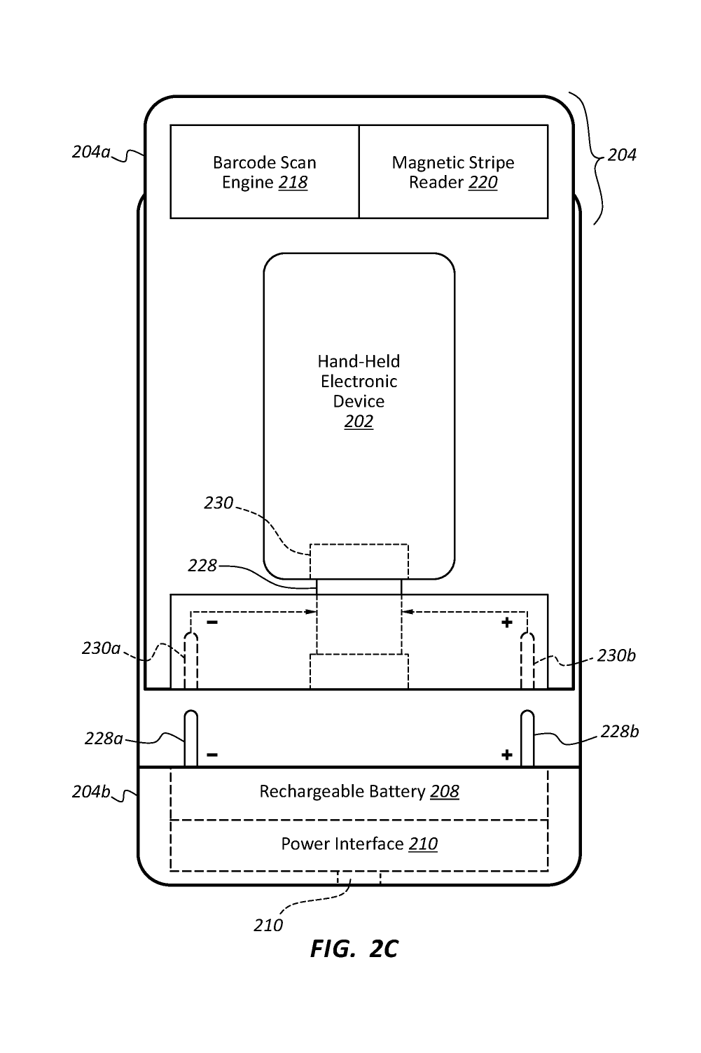

FIGS. 2A through 2C illustrate another configuration of an accessory 200 for a hand-held electronic device 202. This accessory 200 is similar to the accessory 100 described previously, except as indicated below.

In this accessory 200, the protective case 204 comprises a first part 204a and a second part 204b. The electronic device 202 is insertable into the first part 204a of the protective case 204. The first and second parts 204a, 204b of the protective case 204 are detachable from one another, as shown in FIG. 2A. The first and second parts 204a, 204b are also attachable to one another, as shown in FIG. 2B.

Attaching the first and second parts 204a, 204b comprises positioning the first and second parts 204a, 204b in the manner shown in FIG. 2A, and then sliding the second part 204b into the first part 204a such that connectors 228a, 228b in the second part 204b engage receptacles 230a, 230b in the first part 204a. Friction or a mechanical latch between the connectors 228a, 228b and the receptacles 230a, 230b keep the first and second parts 204a, 204b attached to one another.

FIG. 2B shows the protective case 204 with the first and second parts 204a, 204b attached together. As shown in FIG. 2C, when the first and second parts 204a, 204b are attached, there is an electrical connection between the rechargeable battery 208 and the electronic device 202, so that the rechargeable battery 208 can provide power to the electronic device 202 when needed.

FIG. 2C also shows that the first part 204a of the protective case 204 comprises a barcode scan engine 218 and a magnetic stripe reader 220. The second part 204b of the protective case 204 comprises the rechargeable battery 208 and a power interface 210 that allows the accessory 200 to be connected to a power source in order to charge the battery 208. In an alternative configuration, the power interface 210 may be included in the first part 204a of the protective case 204.

The battery 208 is replaceable without having to remove the electronic device 202 from the protective case 204. Replacing the battery 208 comprises detaching the second part 204b of the protective case 204 from the first part 204a of the protective case 204, and attaching a replacement second part (which includes a new battery) to the first part 204a.

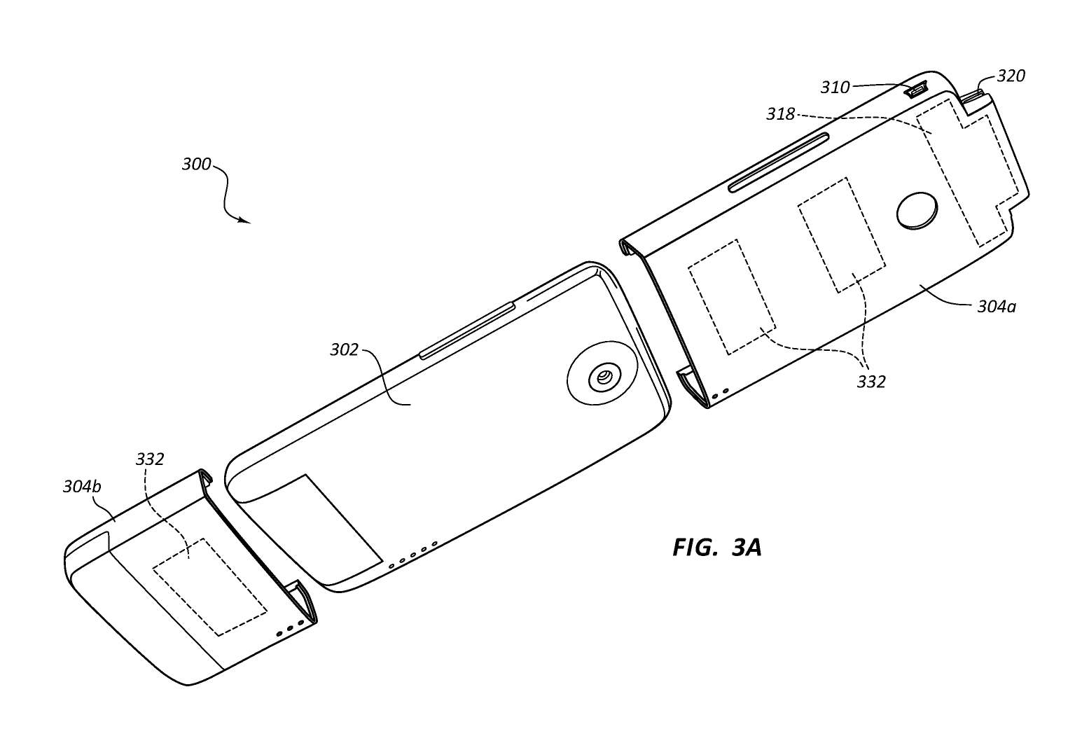

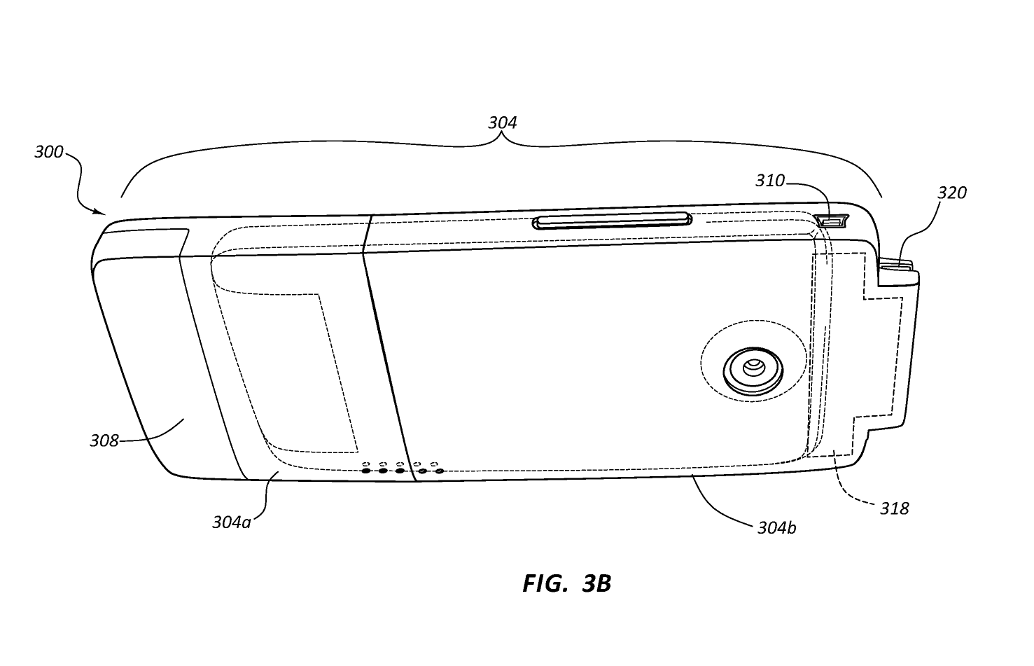

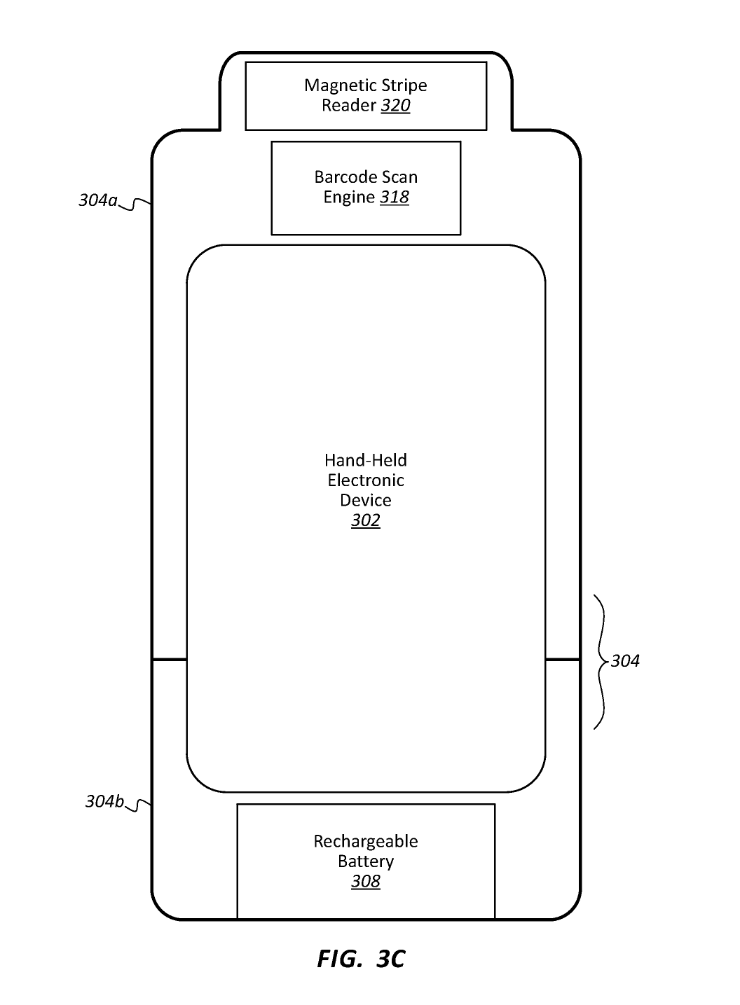

FIGS. 3A through 3C illustrate another configuration of an accessory 300 for a hand-held electronic device 302. This accessory 300 is similar to the accessory 200 described previously, except as indicated below.

In this accessory 300, inserting the electronic device 302 into the protective case 304 comprises pushing the top part of the electronic device 302 into the first part 304a of the protective case 304, and sliding the second part 304b of the protective case 304 onto the bottom part of the electronic device 302. After the electronic device 302 has been inserted into the protective case 304, the protective case 304 remains in place for at least two reasons. First, the dimensions of the first and second parts 304a, 304b are such that the electronic device 302 fits tightly within them. Second, the interior portions of the first and second parts 304a, 304b comprise felt pads 332. Friction between the felt pads 332 and the electronic device 302 also helps to keep the protective case 304 in place.

The battery 308 is replaceable without having to remove the electronic device 302 from the protective case 304. Replacing the battery 308 comprises removing the second part 304b of the protective case 304 from the bottom part of the electronic device 302, and sliding a replacement second part (which includes a new battery) onto the bottom part of the electronic device 302.

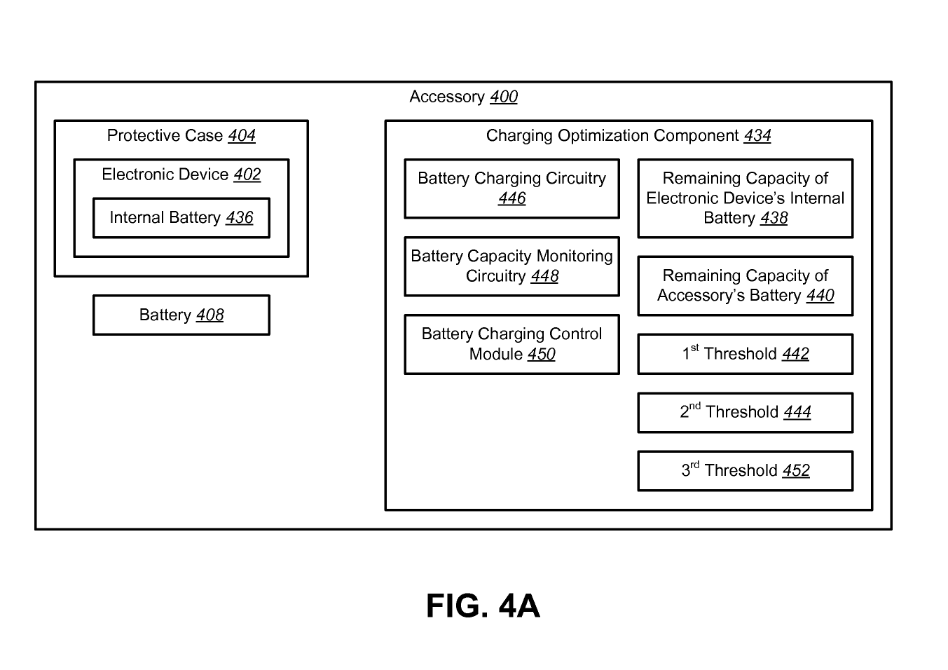

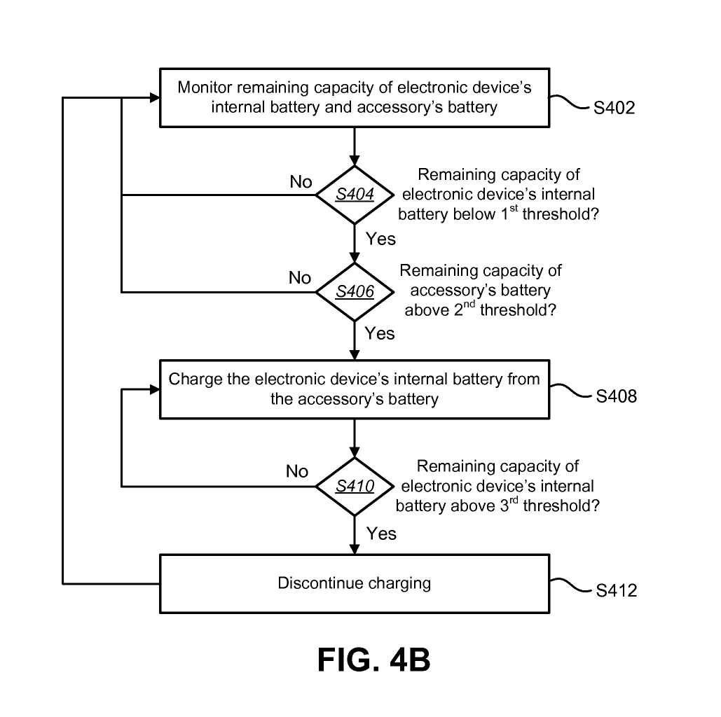

Another accessory 400 for a hand-held electronic device 402 will be described in connection with FIGS. 4A and 4B. The accessory 400 includes a battery 408 that provides auxiliary power to the electronic device 402. The accessory 400 also includes a component 434 that is configured to charge an internal battery 436 of the electronic device 402 from the accessory's battery 408 based on the remaining capacity 438 of the electronic device's internal battery 436 and the remaining capacity 440 of the accessory's battery 408. This component 434 may be referred to as a charging optimization component 434.

The charging optimization component 434 may be configured to operate as shown in FIG. 4B. In step S402, the charging optimization component 434 may monitor the remaining capacity 438 of the electronic device's internal battery 436 and the remaining capacity 440 of the accessory's battery 408. In step S404, the charging optimization component 434 may determine whether the remaining capacity 438 of the electronic device's internal battery 436 is below the first threshold 442. If so, then in step S406 the charging optimization component 434 may determine whether the remaining capacity 440 of the accessory's battery 408 is above the second threshold 444. If so, then in step S408 the charging optimization component 434 may charge the electronic device's internal battery 436 from the accessory's battery 408.

Charging may continue until the remaining capacity 438 of the electronic device's internal battery 436 is above a third threshold 452. More specifically, in step S410, it may be determined whether the remaining capacity 438 of the electronic device's internal battery 436 is above the third threshold 452. If not, then the charging performed in step S408 may continue. However, once it is determined that the remaining capacity 438 of the electronic device's internal battery 436 is above the third threshold 452, then in step S412 charging may be discontinued. The third threshold 452 is higher than the first threshold 442, and may also be higher than the second threshold 444.

The charging optimization component 434 may include battery charging circuitry 446 that charges the electronic device's internal battery 436 from the accessory's battery 408. Charging the electronic device's internal battery 436 from the accessory's battery 408 involves putting additional energy into the electronic device's internal battery 436, where such additional energy is supplied by the accessory's battery 408.

The charging optimization component 434 may also include battery capacity monitoring circuitry 448 that monitors the remaining capacity 438 of the electronic device's internal battery 436 and that also monitors the remaining capacity 440 of the accessory's battery 408. The charging optimization component 434 may also include a battery charging control module 450 that controls the operation of the battery charging circuitry 446 based on input from the battery capacity monitoring circuitry 448.

For example, the battery capacity monitoring circuitry 448 may notify the battery charging control module 450 about the remaining capacity 438 of the electronic device's internal battery 436 and the remaining capacity 440 of the accessory's battery 408. If the remaining capacity 438 of the electronic device's internal battery 436 is below the first threshold 442 and the remaining capacity 440 of the accessory's battery 408 is above the second threshold 444, then the battery charging control module 450 may cause the battery charging circuitry 446 to charge the electronic device's internal battery 436 from the accessory's battery 408. For example, the battery charging control module 450 may send control signals to the battery charging circuitry 446, and these control signals may cause the battery charging circuitry 446 to charge the electronic device's internal battery 436 from the accessory's battery 408. As indicated above, this charging may continue until the remaining capacity 438 of the electronic device's internal battery 436 is above the third threshold 452.

However, if the remaining capacity 438 of the electronic device's internal battery 436 is not below the first threshold 442 and/or the remaining capacity 440 of the accessory's battery 408 is not above the second threshold 444, then the battery charging control module 450 may cause the battery charging circuitry 446 to refrain from charging the electronic device's internal battery 436 from the accessory's battery 408. For example, the battery charging control module 450 may take no action at all, and such inaction may cause the battery charging circuitry 446 to refrain from charging the electronic device's internal battery 436 from the accessory's battery 408.

The battery charging circuitry 446 and the battery capacity monitoring circuitry 448 may be implemented via hardware. The battery charging control module 450 may be implemented via software.

The accessory 400 may include a protective case 404, which may be similar to any of the protective cases 104, 204, 304 described previously. The electronic device 402 may be insertable into the protective case 404.

The claims are not limited to the configurations described above. Various modifications, changes and variations may be made in the arrangement, operation and details of the configurations described herein without departing from the scope of the claims.

What is claimed is:

1. An accessory for a hand-held electronic device, comprising:
a protective case, wherein the electronic device is insertable into the protective case; and
a battery that provides auxiliary power to the electronic device;
wherein the battery is replaceable without having to remove the electronic device from the protective case.

2. The accessory of claim 1, wherein:
an exterior surface of a back side of the protective case comprises a battery cover; and
replacing the battery comprises opening the battery cover, removing the battery from the accessory, inserting a new battery into the accessory, and closing the battery cover.

3. The accessory of claim 1, wherein:
the battery is rechargeable; and
the accessory comprises a power interface that enables the accessory to be connected to a power source in order to charge the battery.

4. The accessory of claim 1, further comprising a barcode scan engine.

5. The accessory of claim 1, further comprising a magnetic stripe reader.

6. The accessory of claim 1, wherein:
the accessory comprises a barcode scan engine, a magnetic stripe reader, and a communication interface; and
data that is generated by the barcode scan engine and data that is generated by the magnetic stripe reader are provided to the electronic device via the communication interface.

7. The accessory of claim 1, wherein:
the protective case comprises a first part and a second part;
the electronic device is insertable into the first part of the electronic device;
the first part and the second part of the protective case are detachable from one another; and
the first part and the second part of the protective case are attachable to one another.

8. The accessory of claim 7, wherein:
attaching the first part and the second part of the protective case comprises sliding the second part into the first part such that connectors in the second part engage receptacles in the first part; and
friction between the connectors and the receptacles keep the first part and the second part of the protective case attached to one another.

9. The accessory of claim 7, wherein when the first part and the second part of the protective case are attached to one another, there is an electrical connection between the battery and the electronic device.

10. The accessory of claim 7, wherein:
the first part of the protective case comprises a barcode scan engine and a magnetic stripe reader; and
the second part of the protective case comprises the battery and a power interface.

11. The accessory of claim 7, wherein:
the first part of the protective case comprises a barcode scan engine, a magnetic stripe reader, and a power interface; and
the second part of the protective case comprises the battery.

12. The accessory of claim 7, wherein replacing the battery comprises:
detaching the second part of the protective case from the first part of the protective case; and
attaching a replacement second part of the protective case to the first part of the protective case, wherein the replacement second part comprises a new battery.

13. The accessory of claim 1, wherein:
the protective case comprises a first part and a second part; and
inserting the electronic device into the protective case comprises pushing a top part of the electronic device into the first part of the protective case, and sliding the second part of the protective case onto a bottom part of the electronic device.

14. The accessory of claim 13, wherein:
dimensions of the first part and the second part of the protective case are such that the electronic device fits tightly within them; and
interior portions of the first part and the second part of the protective case comprise felt pads.

15. The accessory of claim 13, wherein replacing the battery comprises:
removing the second part of the protective case from the bottom part of the electronic device; and
sliding a replacement second part onto the bottom part of the electronic device, wherein the replacement second part comprises a new battery.

16. An accessory for a hand-held electronic device, comprising:
a battery that provides auxiliary power to the electronic device; and
a charging optimization component that is configured to charge an internal battery of the electronic device from the accessory's battery based on the remaining capacity of the electronic device's internal battery and the remaining capacity of the accessory's battery.

17. The accessory of claim 16, wherein the charging optimization component is configured to charge the internal battery of the electronic device from the accessory's battery only if the remaining capacity of the electronic device's internal battery is below a first threshold and the remaining capacity of the accessory's battery is above a second threshold.

18. The accessory of claim 17, wherein:
the charging of the internal battery of the electronic device from the accessory's battery continues until the remaining capacity of the electronic device's internal battery is above a third threshold; and
the third threshold is higher than the first threshold.

19. The accessory of claim 18, wherein the third threshold is also higher than the second threshold.

20. The accessory of claim 16, wherein the charging optimization component comprises:
battery charging circuitry that charges the electronic device's internal battery from the accessory's battery;
battery capacity monitoring circuitry that monitors the remaining capacity of the electronic device's internal battery and that also monitors the remaining capacity of the accessory's battery; and
a battery charging control module that controls the operation of the battery charging circuitry based on input from the battery capacity monitoring circuitry.
